(19) United States
(12) Patent Application Publication
(10) Pub. No.: US 2007/0111081 A1
(43) Pub. Date: May 17, 2007

(54) Bipolar plate or electrode plate for fuel cells or electrolyzer stacks, as well as a method for producing a bipolar plate or electrode plate for fuel cells or electrolyzer stacks

(76) Inventor: Michael Martin, Solms-Oberbiel (DE)

Correspondence Address: WILLIAM COLLARD;COLLARD & ROE, P.C., 1077 NORTHERN BOULEVARD, ROSLYN, NY, 11576, US

(21) Appl. No.: 11/499,321

(22) Filed: Aug. 4, 2006

(30) Foreign Application Priority Data
Aug. 4, 2005 (DE) DE 102005037345.3

(51) Int. Cl. H01M 8/02; C25B 9/00; B29C 69/00; B29B 13/00

(52) U.S. Cl. 429/38; 204/277; 264/241; 264/271.1

(57) ABSTRACT

Bipolar plate or electrode plate for fuel cells or electrolyzer stacks, which is formed from a conductive material, and in which the conductive material is at least partly configured to be surrounded by a non-conductive material, by means of injection molding, or which is composed of individual parts made of conductive and non-conductive material, whereby channels for reagents are formed by the non-conductive material, whereby an anode divided into segments and a cathode of the bipolar plate or electrode plate, divided into segments, have at least one parting point in a conductive structure, in each instance.

### SPECIFICATION

The invention relates to a bipolar plate or electrode plate for fuel cells or electrolyzer stacks, as well as to a method for producing a bipolar plate or electrode plate for fuel cells or electrolyzer stacks.

According to the state of the art, fuel cells are formed from several bipolar plates or electrode plates that are joined together. For the sake of simplicity, the following explanations are presented with reference to bipolar plates. However, electrode plates are meant equally.

Since every bipolar plate can only reach a voltage of approximately 0.5 volts, it is necessary, according to the state of the art, to provide a corresponding number of bipolar plates in order to reach a specific voltage and a specific output, which is determined by the field of use of the fuel cell, in order to achieve the required output of the fuel cell. Since the voltage is not sufficient, in most cases, in this case an electronic control has to be provided, in order to generate the required voltage.

In most cases, this electronic control is complicated and expensive.

The technical problem on which the invention is based consists in indicating a fuel cell having bipolar plates or electrode plates, with which a required output and, at the same time, a required voltage can be achieved, without any or with only slight expenditure for an additional electronic control. Furthermore, a method for producing such bipolar plates or electrode plates is supposed to be indicated.

The technical problem on which the invention is based is solved by means of a bipolar plate or electrode plate having the characteristics according to claim 1, as well as by means of a method having the characteristics according to claim 13.

The bipolar plate or electrode plate for fuel cells or electrolyzer stacks, according to the invention, which is formed from a conductive material, and in which the conductive material is at least partly configured to be surrounded by a non-conductive material, by means of injection molding, whereby channels for reagents are formed by the non-conductive material, is characterized in that an anode divided into segments and a cathode of the bipolar plate or electrode plate, divided into segments, have at least one parting point in a conductive structure, in each instance.

The bipolar plate or electrode plate is configured in such a manner, as known from the state of the art (EP 1 517 388 A1), that for producing the bipolar plates or electrode plates divided into segments, the bipolar plate or electrode plate has at least one punched strip and/or at least one blank that is punched from a planar material of a conductive and corrosion-protected metal, or is given a-corresponding surface, and that the contact surfaces to the anodes divided into segments, or to the cathodes divided into segments, respectively, are alternately displaced to both sides from the original plane, and that in a further method step, the at least one punched strip and/or the at least one blank is surrounded at least in part with plastic, by means of injection molding, or is joined together from individual parts, in such a manner that channels for conducting reagents through are formed between the punched conductive tracks.

It is advantageous if the bipolar plate or electrode plate configured in this manner is divided up, in that at least one metal strip of the anode and at least one metal strip of the cathode are electrically connected with one another, and in that at least one other strip of the anode and at least one other strip of the cathode are also electrically connected with one another, but separately from the at least first strip of the anode and the at least first strip of the cathode. In this way, it is possible to produce a bipolar plate or electrode plate having a higher output voltage.

In this manner, at least one parting point can be achieved in the anode that is divided into segments and in the cathode that is divided into segments, of the bipolar plate or electrode plate, with an interconnection.

It is advantageous if the parting points divide the conductive structures into two planes, which are formed by metal strips, in each instance.

According to a particularly preferred embodiment of the invention, the planes of the metal strips of the anode and of the metal strips of the cathode are interconnected so as to intersect.

The voltage and the current intensity can be selected in variable manner on a flow field, by means of the variable parting points.

It is possible to dispose the bipolar plate or electrode plate that has been divided into segments in the fuel cell as a planar bipolar plate or planar electrode plate, or as a folded bipolar plate or electrode plate.

The punching and injection-molding die preferably has a modular structure, so that bipolar plates or electrode plates having the required number of parting points can be produced by means of the exchange and use of corresponding inserts in the punching and injection-molding die, with one and the same punching and injection-molding die.

In this way, it is possible for a bipolar plate (cell) that has been divided into segments to be divided up into several bipolar plates, with the required interconnection, whereby the process step of punching and injection molding takes place in a combined die, or joined by means of assembly. The same holds true for the electrode plates.

Usually, in the case of a bipolar plate (cell), only a voltage of 0.5 volts, for example, can be achieved. In the case of an interconnection of four cells on a bipolar plate half, in each instance, a voltage of approximately two volts can therefore be achieved in this manner, and in the case of an interconnection of eight cells on a bipolar plate half, in each instance, a voltage of approximately four volts can be achieved, without a voltage transformer being required.

It is necessary for the gas diffusion layer (GDL), which is disposed between the bipolar plates, also to be divided into segments, accordingly.

The at least one membrane is configured as an undivided membrane.

On the one half of the bipolar plate, hydrogen (H₂) is distributed in the flow field, and on the second half of the bipolar plate, air or oxygen is distributed.

In the next plane, in the case of a bipolar plate stack, an air flow field lies above the half of the hydrogen flow field, and on the second half, a hydrogen flow field lies above the air flow field. In between, in each instance, there is a membrane having gas diffusion layers (GDL) divided into segments.

It is advantageous if the bipolar plate stack has the connections on the first and the last cell, and multiple connectors, in accordance with the division.

These connectors can be switched in parallel and/or in series, for example with a selection switch or plug-in contacts.

In this way, the fuel cell can be simply switched to several voltages, without electronics, and no voltage transformer is required.

With regard to details of the production of the bipolar plates, reference is made to EP 1 517 388 A1.

Planar material according to the invention is understood to mean blanks, strips, or strip material. For the sake of simplicity, the following explanations will be given with reference to strip material. However, they are equally intended for the implementation of blanks and strips.

In a method step for the production of the bipolar plate or electrode plate divided into segments, the at least one punched strip and/or the at least one blank is/are at least partially surrounded with plastic, by means of injection molding. The plastic injection molding takes place in such a manner that channels for conducting reagents through are formed with the plastic, between the punched conductive tracks.

The metal strips are merely surrounded in part, by means of injection molding, in such a manner that during assembly of the bipolar plate or electrode plate that has been divided into segments, the metal strips are in direct contact with a gas diffusion layer of a membrane having gas diffusion layers (GDL) divided into segments.

According to the invention, the bipolar plate or electrode plate is divided into segments, in other words the anode and/or the cathode are divided into segments.

In a first method step, it is advantageous if the strip material is partially incised in strip shape. Subsequently, the strips are pushed out of a center position, and subsequently the injection-molding process is carried out. During this punching process, the parting points, in other words the punched lines for the division of the plate, are formed at the same time.

During the injection-molding process, the strips are pushed into their end position and partially surrounded by means of injection-molding there, so that they are given a fixed position in the plastic, which at the same time forms the channels for the reagents.

A stack can be produced from these bipolar plates, in simple manner, in that the plates that are connected with one another to form the stack are stacked on top of one another, by means of 180° bends, in each instance. A membrane carrying at least one gas diffusion layer is disposed between the plates. It is also possible to stack the plates on top of one another without bends, in other words in the planar shape, as they are produced.

It is advantageous if the progression of the channels in a flow is disposed parallel between the plate planes that lie opposite one another, so that two punched tracks or plates that lie opposite one another, in each instance, formed from the strip material and partially surrounded with plastic, by means of injection molding, are disposed on both sides of the membrane that carries the gas diffusion layer, resting against it, with pressure.

It is advantageous if a stack is built up by forming a series of segments that are the same, whereby a segment of a bipolar plate has distributor channels as well as connectors for the reagents and a membrane electrode unit (MEA—membrane electrode assembly). The membrane electrode unit of a first segment forms the delimitation of the second segment, which is sealed for gas and electrically insulating, but proton-conductive. The membrane electrode unit of the second segment forms the delimitation of the third segment, which is sealed for gas and electrically insulating, but proton-conductive, and so forth.

It is advantageous if end plates are disposed at both ends of the stack, between which the individual segments ordered in series with one another are clamped, with their seals. It is advantageous if the end plates have connectors for feeding in and draining off reagents.

Combining the metal with the plastic, according to the invention, is particularly advantageous. The metal strips are partially surrounded with plastic, by means of injection molding, whereby channels for the reagents are formed by the plastic. The punched strips or blanks are surrounded with plastic, by means of injection molding, in such a manner that they can be disposed resting directly on a gas diffusion layer of the membrane. The configuration of the plastic channels is advantageously selected in such a manner that the gas does not come directly into contact with the metal plates. The metal plates either rest against the gas diffusion layer, or they are surrounded with plastic, by means of injection molding. Because the channels are completely sealed with plastic, or delimited towards the open side by the membrane having the gas diffusion layers, respectively, no short circuit can occur.

According to an advantageous embodiment of the invention, the metal strips of one plane of the anode that is divided into segments, and the metal strips of a plane of the cathode that is divided into segments, are disposed on a common metal strip, in each instance, and the at least one parting point divides the common metal strip electrically into several regions. This is a structure that is particularly simple to produces.

It is advantageous if the metal strips are configured to be insulated against the plastic channels that carry reagents.

According to another advantageous embodiment, connectors, connections, and cross-sections are designed for use as an electrolyzer. In this way, the field of use of the bipolar or electrode plate according to the invention is varied.

By means of punching the metal conductors, it is possible to configure them to be very narrow (up to approximately one millimeter), so that very small but nevertheless high-performance fuel cells for small devices, for example for laptops, cameras, camcorders, or also for stationary applications, such as camping, trailers, as well as emergency power units (UPS—uninterruptible power supply) can be produced.

The production method according to the invention is characterized by the following advantages:
1. The conductive tracks are formed from a piece of sheet metal, complete and without waste, whereby the parting points are formed at the same time,
2. the conductive tracks are alternately displaced towards both sides of the blank or punched strip, and fixed in place in their position there, by being partially surrounded with plastic, by means of injection molding,
3. the injection-molding die inserts, which are configured in comb shape, at the same time form the cavities that later form the channels for the gas,
4. the metal conductors are pressed into their final position during the injection-molding process.

In this way, it is possible to form bipolar plates in a relatively inexpensive process.

In order to be able to divide a bipolar plate or electrode plate into segments, it is necessary to dispose the progression of the channels in the flow field parallel between the opposite plate planes, and to allow the two metal contact strips that lie directly opposite one another to press down on the membrane electrode unit or gas diffusion layer, respectively, from both sides.

More than four segments are also possible in the division of the bipolar plate or electrode plate. It is absolutely possible to provide even twelve segments or more.

The method of interconnection according to the invention can also be implemented in the case of bipolar plates or electrode plates that belong to the state of the art, for example with a known graphite/composite solution.

According to a further advantageous embodiment, the strips are merely partially incised during the punching process and/or connecting crosspieces are formed. In this way, the production method is simplified.

It is advantageous if channels for carrying the reagents are preformed or formed in finished manner in a working region of the punched blanks or punched strips. In this way, the production of the bipolar or electrode plates according to the invention is clearly simplified.

Instead of hydrogen, methanol or other suitable substances can also be used, for example.

Additional characteristics and advantages of the invention are evident from the related drawing, in which several exemplary embodiments are shown only as examples. The drawing shows:

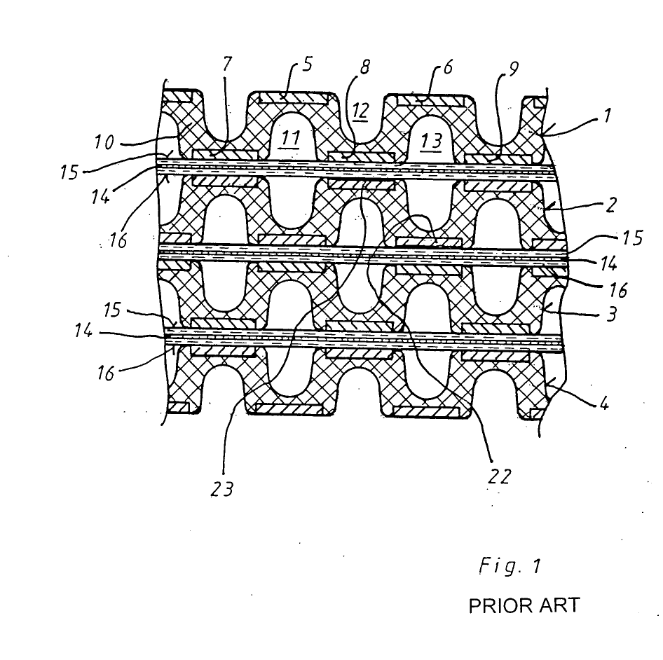

FIG. 1 a longitudinal section through a stack of bipolar plates (state of the art);

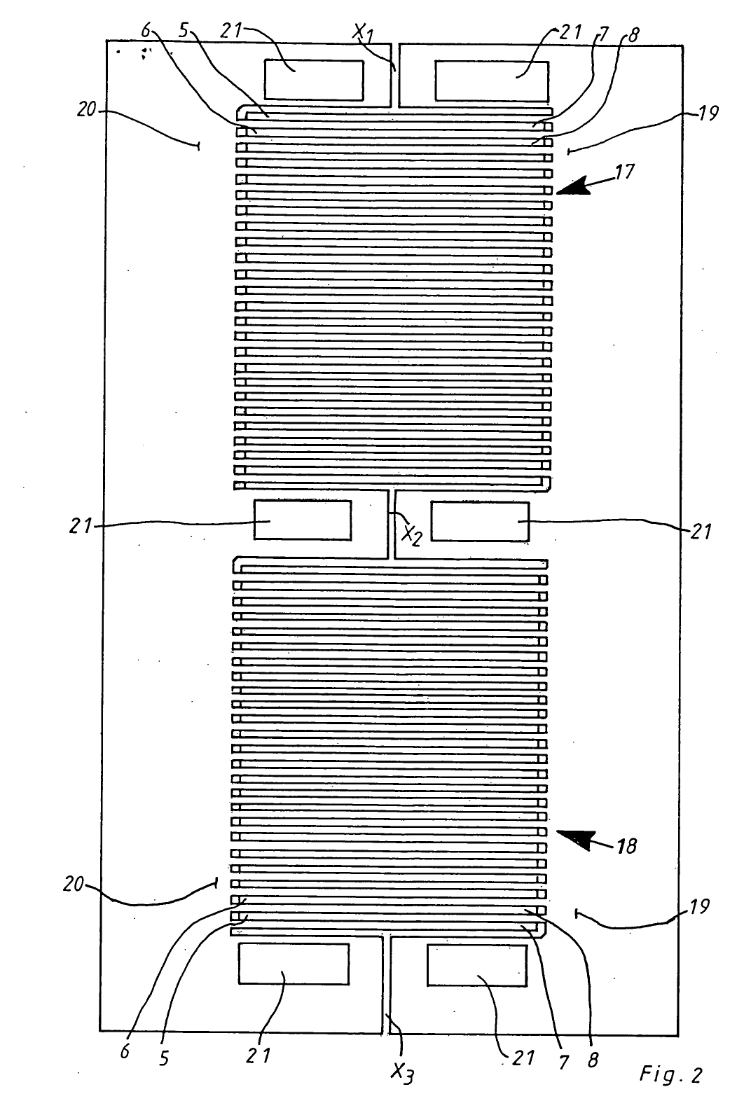

FIG. 2 a one-volt cell with straight plates;

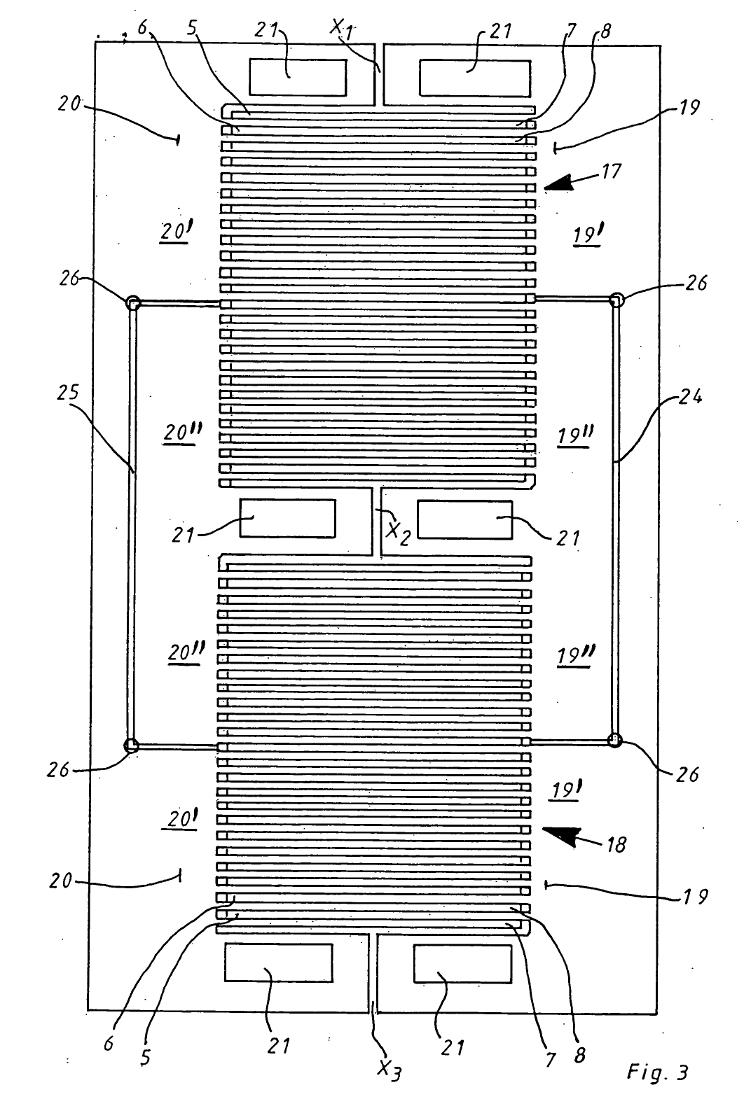

FIG. 3 a two-volt cell with straight plates;

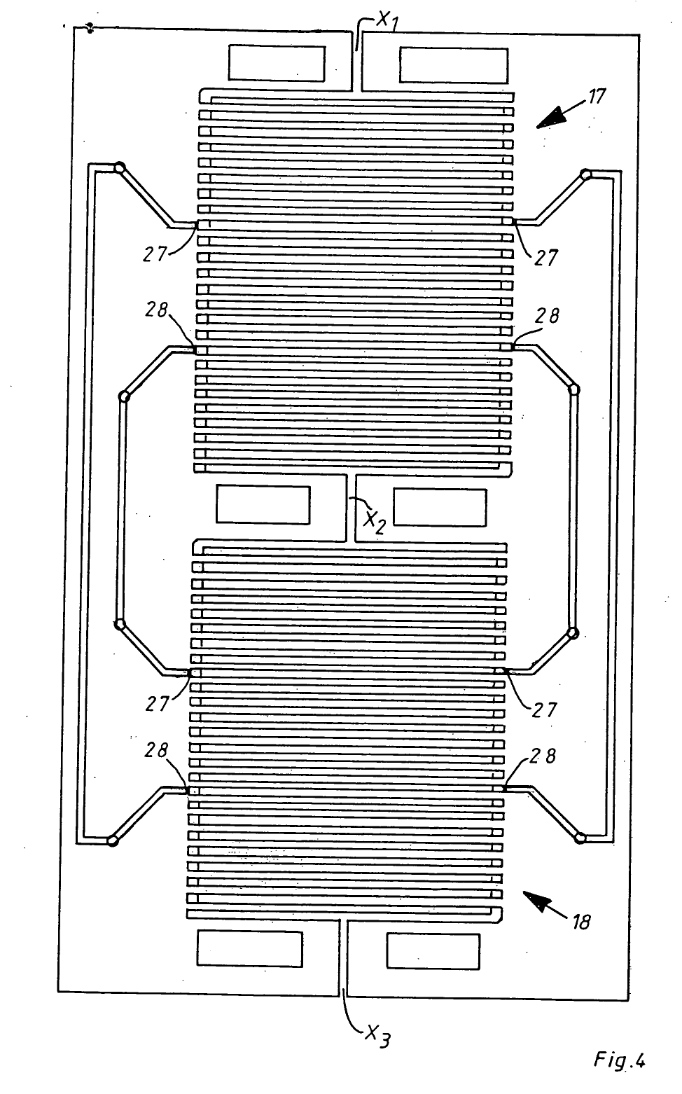

FIG. 4 a three-volt cell with straight plates;

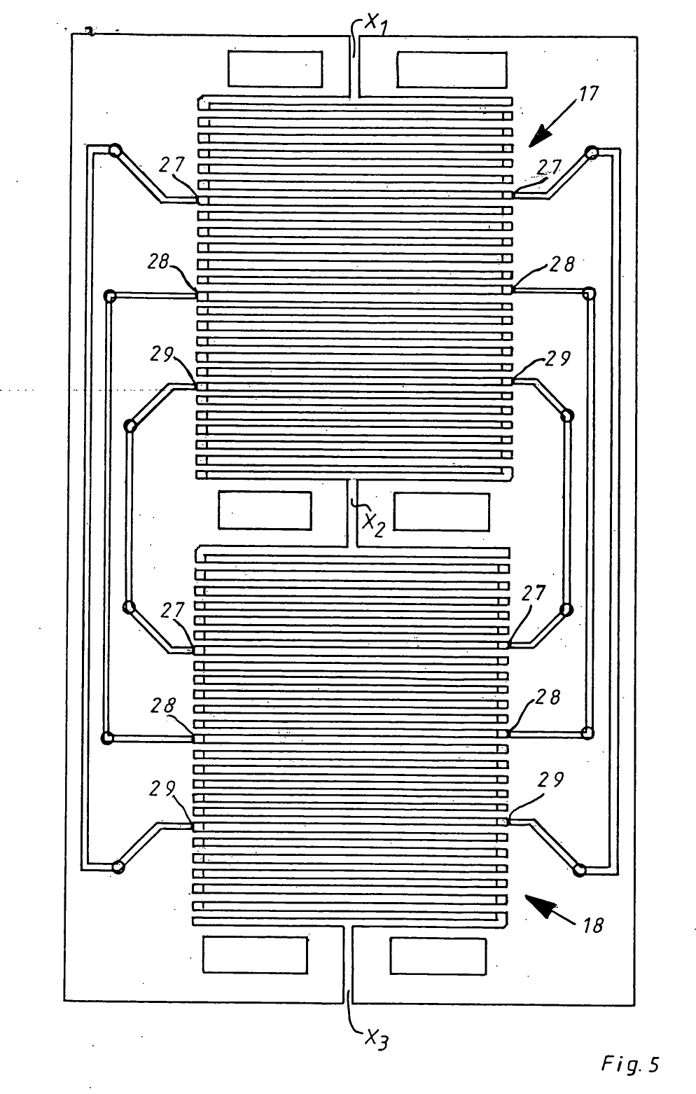

FIG. 5 a four-volt cell with straight plates;

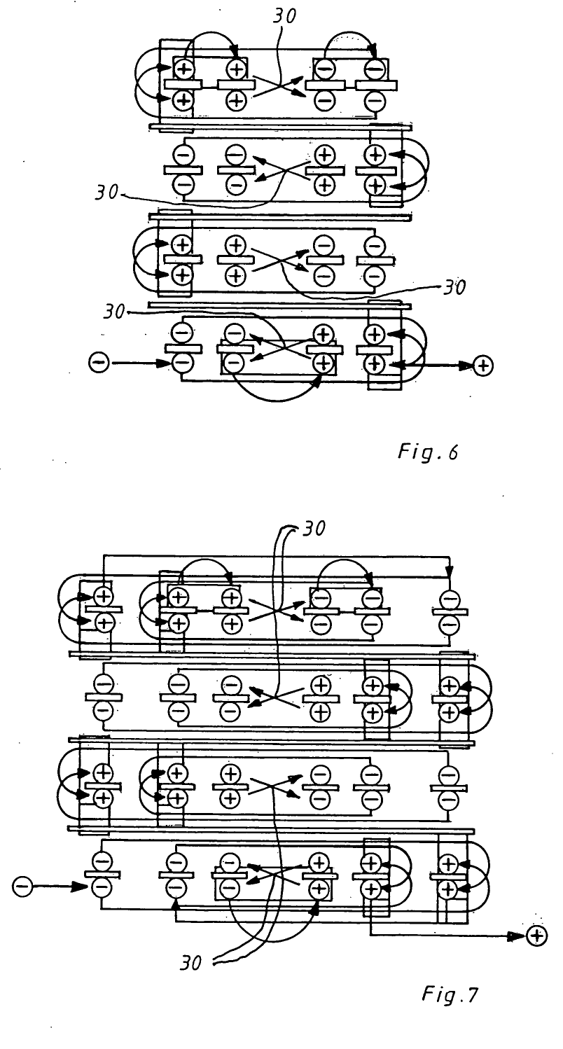

FIG. 6 a two-volt cell (serial circuit with straight plates) as a fundamental connection diagram;

FIG. 7 a three-volt cell (serial circuit with straight plates) as a fundamental circuit.

FIG. 1 shows bipolar plates 1, 2, 3, 4 that belong to the state of the art. The electrode plate 1 has metal strips 5 to 9 that were originally punched from a piece of sheet metal. In the sheet metal, the metal strips 7, 5, 8, 6, 9 were disposed lying next to one another. Channels 11, 12, 13 for the reagent gas or the reagent liquid (not shown here) are formed by means of a plastic 10. A membrane 14 having gas diffusion layers 15, 16 is disposed between the electrode plate 1 and the electrode plate 2. The electrode plates 1, 2 are pressed onto the gas diffusion layers 15, 16 with a certain contact pressure.

FIG. 2 shows the first step in the division of the bipolar plate. In this connection, the basic shape is divided into two planes by means of the parting X1, X2, X3. In this connection, the metal strips 5, 6 form a first plane, and the metal strips 7, 8 form a second plane. The two planes are insulated from one another by means of a plastic (10), as shown in FIG. 1.

The metal strips 5, 6 of the anode 17 and the cathode 18 shown in FIG. 2 are electrically connected with one another by way of a common metal strip 19. The metal strips 7, 8 of the anode 17 and the cathode 18 are electrically connected with one another by way of a common metal strip 20.

In order to be able to implement an electrical serial circuit in a stack of the bipolar plates or electrode plates, it is necessary to displace the metal strips 5, 6 of the anode into the upper plane, and the metal strips 5, 6 of the cathode into the lower plane. The metal strips 7, 8 are disposed in the opposite manner. By means of this intersecting interconnection 30 shown in FIG. 6 and FIG. 7, two bipolar plates with double voltage, which are independent of one another, are formed. These bipolar plates or electrode plates that are divided into segments can be stacked both as planar plates and as folded bipolar plates or electrode plates.

The anode 17 and the cathode 18 consist of metal strips 5 to 9, which are punched out, pushed out of a plane, and surrounded with plastic, by means of injection-molding, during the production process, or joined together or composed of individual parts.

FIG. 3 shows a two-volt cell. The regions 19, 20 are divided into the regions 19′, 19″, 20′, 20″ by mans of a punched line 24, which is produced during the punching process, and a corresponding punched line 25. The same holds true for the regions 19, 20 of the cathode 18. In this way, four cells are formed, causing the voltage to be quadrupled. The parting lines 24, 25 are fixed in place with plastic at points 26, in order to prevent the regions 19′, 19″, 20′, 20″ from coming into contact with one another, for example due to fluttering.

In FIG. 3, inflow and outflow channels 21 are also shown.

FIG. 4 shows a three-volt cell. The anode 17, which is divided into segments, as well as the cathode 18, which is divided into segments, are divided into three regions by means of two parting points 27, 28, so that the voltage is sextupled.

According to FIG. 5, the anode 17, which is divided into segments, and the cathode 18, which is divided into segments, are divided into four cells, by means of three parting points 27, 28, 29, so that an octuple voltage (four volts) can be achieved with this bipolar plate.

FIG. 6 shows the interconnection of the two-volt cell according to FIG. 3. The intersecting interconnection 30 of the anodes and cathodes of the straight bipolar plates or electrode plates, which anodes and cathodes are divided into two parts, in each instance, becomes visible by means of the arrows, per cell.

FIG. 7 shows the interconnection of the three-volt cell according to FIG. 4. The intersecting interconnection 30 of the anodes and cathodes of the straight bipolar plates or electrode plates, which anodes and cathodes are divided into three parts, in each instance, becomes visible by means of the arrows, per cell.

### Reference Numbers

1 to 4 electrode plates/bipolar plates
5 to 9 metal strips
10 plastic or plastic part
11 to 13 channels
14 membrane
15, 16 gas diffusion layers
17 anode
18 cathode
19, 19′, 19″ metal strips
20, 20′, 20″ metal strips
21 inflow and outflow channels
22 conductive track
23 conductive track
24 punched line
25 punched line
26 points
27 parting point
28 parting point
29 parting point
30 intersecting interconnection
X1 parting point
X2 parting point
X3 parting point

1. Bipolar plate or electrode plate for fuel cells or electrolyzer stacks, which is formed from a conductive material, and in which the conductive material is at least partly configured to be surrounded by a non-conductive material, by means of injection molding, or which is composed of individual parts made of conductive and non-conductive material, whereby channels for reagents are formed by the non-conductive material,
wherein an anode (17) divided into segments and a cathode (18) of the bipolar plate or electrode plate, divided into segments, have at least one parting point (X1, X2, X3, 24, 25, 27, 28, 29) in a conductive structure, in each instance.

2. Bipolar plate or electrode plate according to claim 1, wherein the bipolar plate or electrode plate has a punched strip and/or at least one blank having strips of punched planar material made of a conductive and corrosion-resistant metal, and in which the at least one punched strip or the at least one blank is configured to be at least partially surrounded by a non-conductive material, by means of injection molding, and that the strips are disposed in two planes relative to one another.

3. Bipolar plate or electrode plate according to claim 1, wherein the non-conductive material is plastic.

4. Bipolar plate or electrode plate according to claim 1, wherein the parting points (X1, X2, X3) divides the conductive structures into two planes, which are formed by metal strips (5, 6) and metal strips (7, 8).

5. Bipolar plate or electrode plate according to claim 1, wherein at least one first metal strip (5, 6) of the anode (17) that is divided into segments, and at least one first metal strip (5, 6) of the cathode (18) that is divided into segments are electrically connected with one another, and that at least one other metal strip (7, 8) of the anode (17) that is divided into segments and at least one other metal strip (7, 8) of the cathode (18) that is divided into segments are also electrically connected with one another, and that the first and the other metal strips (5, 6; 7, 8) are configured to be electrically insulated from one another.

6. Bipolar plate or electrode plate according to claim 1, wherein the planes of the metal strips (5, 6) of the anode (17) and of the metal strips (5, 6) of the cathode (18) are interconnected in intersecting manner, and that the planes of the metal strips (7, 8) of the anode (17) and of the metal strips (7, 8) of the cathode (18) are interconnected in intersecting manner.

7. Bipolar plate or electrode plate according to claim 1, wherein the metal strips (5, 6) of one plane of the anode (17) and of the cathode (18) that are divided into segments, and the metal strips (7, 8) of one plane of the anode (17) and the cathode (18) that are divided into segments are disposed on a common metal strip (19, 20), in each instance, and that the at least one parting point (24, 25, 27, 28, 29) separates the common metal strip (19, 20) electrically into several regions (19′, 19″, 20′, 20″).

8. Bipolar plate or electrode plate according to claim 1, wherein the bipolar plate (1, 2, 3) is configured as a folded plate.

9. Bipolar plate or electrode plate according to claim 1, wherein the bipolar plate (1, 2, 3) is configured as a planar plate.

10. Bipolar plate or electrode plate according to claim 1, wherein a gas diffusion layer (15, 16) is configured to be divided into segments.

11. Bipolar plate or electrode plate according to claim 1, wherein a membrane is configured as an undivided membrane (14).

12. Bipolar plate or electrode plate according to claim 1, wherein connectors, connections, and cross-sections are designed for use as an electrolyzer.

13. Method for producing bipolar plates or electrode plates divided into segments, for fuel cell stacks or electrolyzer stacks, with the following method steps:
the bipolar plate or electrode plate that is divided into segments has at least one punched strip and/or at least one blank, which is punched from a planar material made of a conductive and corrosion-resistant metal,
the planar material is incised in strip shape, whereby at least one parting point (X1, X2, X3, 24, 25, 27, 28, 29) is formed,
the strips are pushed out of a center position,
an injection-molding process is carried out, in such a manner that the strips are held by plastic.

14. Method according to claim 13, wherein the at least one punched strip and/or the at least one blank is surrounded by plastic, by means of injection molding, or joined together from individual parts, in such a manner that channels for passing through reagents are formed with the plastic.

15. Method according to claim 13, wherein the strips are merely partially incised during the punching process, and/or connection crosspieces are formed.

16. Method according to claim 13, wherein channels for carrying the reagents are preformed or formed in finished manner in a working region of the punched blanks or punched strips.
